(19) United States
(12) Patent Application Publication
(10) Pub. No.: US 2014/0060966 A1
(43) Pub. Date: Mar. 6, 2014

(54) D-Ring with Rescue Attachment and Lanyard Attachments Integrated

(71) Applicants: Parul Patel, Franklin, PA (US); Shelly L. Mihalic, Franklin, PA (US); Preston L. Anderson, Cranberry, PA (US); Douglas A. Mercier, Mars, PA (US)

(72) Inventors: Parul Patel, Franklin, PA (US); Shelly L. Mihalic, Franklin, PA (US); Preston L. Anderson, Cranberry, PA (US); Douglas A. Mercier, Mars, PA (US)

(73) Assignee: Honeywell International Inc., Morristown, NJ (US)

(21) Appl. No.: 13/603,802

(22) Filed: Sep. 5, 2012

(51) Int. Cl. A44B 11/04; B23P 11/00; A62B 35/00

(52) U.S. Cl. 182/3; 24/265 AL; 29/428

(57) ABSTRACT

Apparatus and associated methods relate to a safety interface plate element that securely attaches to a length of webbing, and further provides a plurality of non-intersecting apertures to couple to a corresponding plurality of safety devices. In an illustrative example, the safety interface plate element may include a slotted opening through which the webbing is threaded. In some examples, the webbing may be removably installed in the slotted opening via a gating mechanism. In some embodiments, the safety interface plate element configured with an embodiment of the gating mechanism may be retrofit to a closed webbing on a pre-fabricated safety harness, for example. In various examples, multiple safety devices may be securely coupled to a safety harness via embodiments of the safety interface plate element.

### TECHNICAL FIELD

Various embodiments relate generally to fall-protection systems.

### BACKGROUND

There are many occupations in which people work in dangerous environments. Working at great heights, for example, is a subset of those dangerous occupations. Some examples of such occupations are building construction, tree care, and exterior building maintenance. In addition to these dangerous occupations, many recreational activities involve working at dangerous heights, such as rock climbing and spelunking. Whenever a person is working or recreating at these heights, that person is at risk of falling.

Every year, people who work or recreate at dangerous heights fall and may suffer serious injury or death. Because of the risks, employers may provide fall-protection devices for their employees. People who recreate at dangerous heights often wear fall-protection devices as well. One purpose of these fall-protection devices is to safely arrest the fall of a person falling from a dangerous height, for example.

Fall-protection devices enable people to perform necessary work in today's building construction industry that absent that safety device few people would perform. These safety devices also permit the enjoyment of recreational activities that otherwise would be frightening. Therefore, improvements in these safety devices help save lives and improve the quality of life.

### SUMMARY

Apparatus and associated methods relate to a safety interface plate element that securely attaches to a length of webbing, and further provides a plurality of non-intersecting apertures to couple to a corresponding plurality of safety devices. In an illustrative example, the safety interface plate element may include a slotted opening through which the webbing is threaded. In some examples, the webbing may be removably installed in the slotted opening via a gating mechanism. In some embodiments, the safety interface plate element configured with an embodiment of the gating mechanism may be retrofit to a closed webbing on a pre-fabricated safety harness, for example. In various examples, multiple safety devices may be securely coupled to a safety harness via embodiments of the safety interface plate element.

Various embodiments may achieve one or more advantages. For example, some embodiments may substantially separate a plurality of safety devices connected to the safety interface plate element, which may thereby advantageously reduce or avoid interferences and/or entanglements. In some safety applications, for example, some embodiments may reduce or eliminate risk of binding, for example, when a rescue hook becomes entangled or constrained by a lanyard in the event of a fall condition. In some examples, the safety interface plate element may be shaped to substantially conform to a portion of an operator's body, such as the mid or lower back region, to improve comfort and potentially reduce injury during fall impact events, for example. Some embodiments may be retrofit to an existing safety harness, which may thereby reduce the cost of replacement of the webbing to obtain the enhanced safety provided by a safety interface plate element capable of multiple connections to safety equipment. Various embodiments may yield improved accessibility to a safety rescue hook to rescue a fallen worker, for example.

The details of various embodiments are set forth in the accompanying drawings and the description below. Other features and advantages will be apparent from the description and drawings, and from the claims.

### BRIEF DESCRIPTION OF THE DRAWINGS

FIGS. 1a-1c depict a sketch of a field implementation of an exemplary Multi-Connector D-Ring (MCDR) used for fall protection.

FIGS. 2a-2b show top and side views of an exemplary MCDR.

FIGS. 3a-3b show top and side views of an exemplary MCDR.

FIGS. 4a-4b show top and side views of an exemplary MCDR.

FIGS. 5a-5b show top and side views of an exemplary MCDR.

FIGS. 6a-6b show top and side views of an exemplary MCDR.

Like reference symbols in the various drawings indicate like elements.

### DETAILED DESCRIPTION OF ILLUSTRATIVE EMBODIMENTS

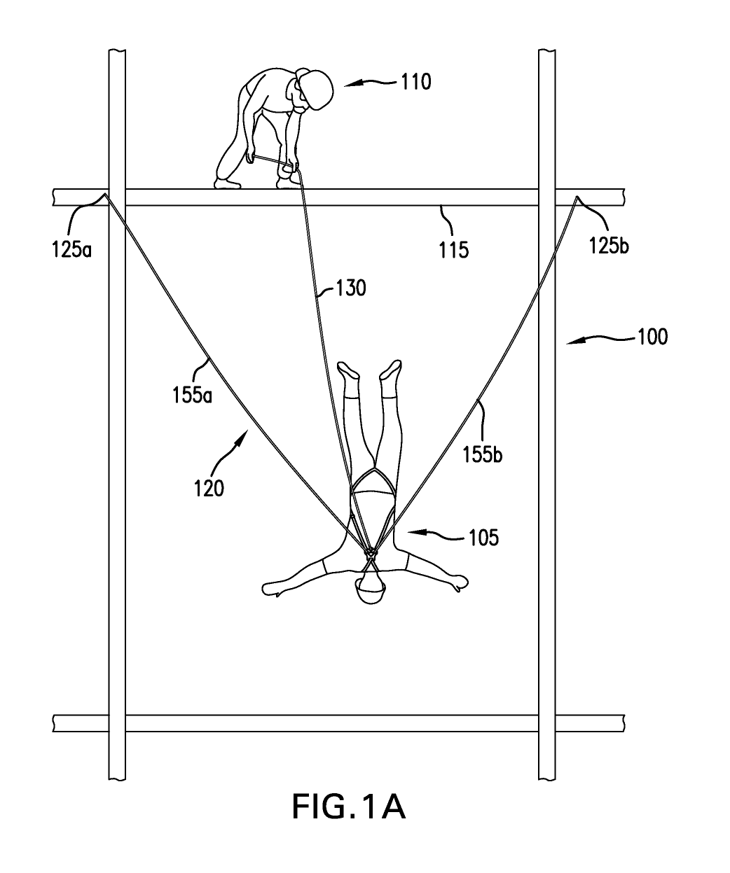

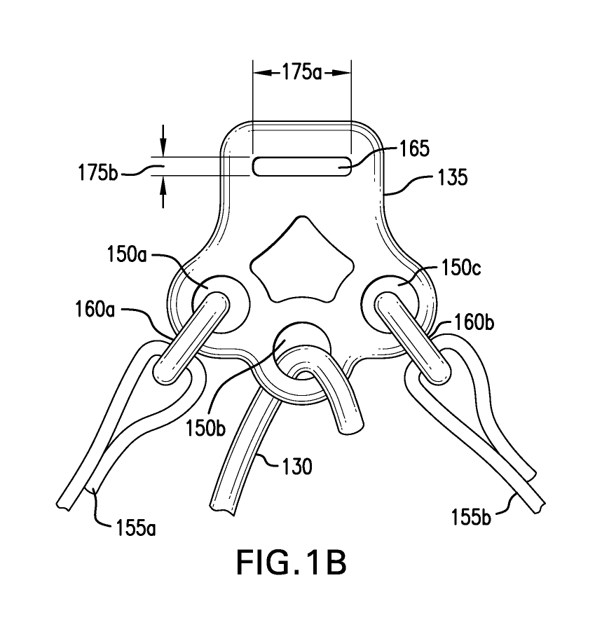

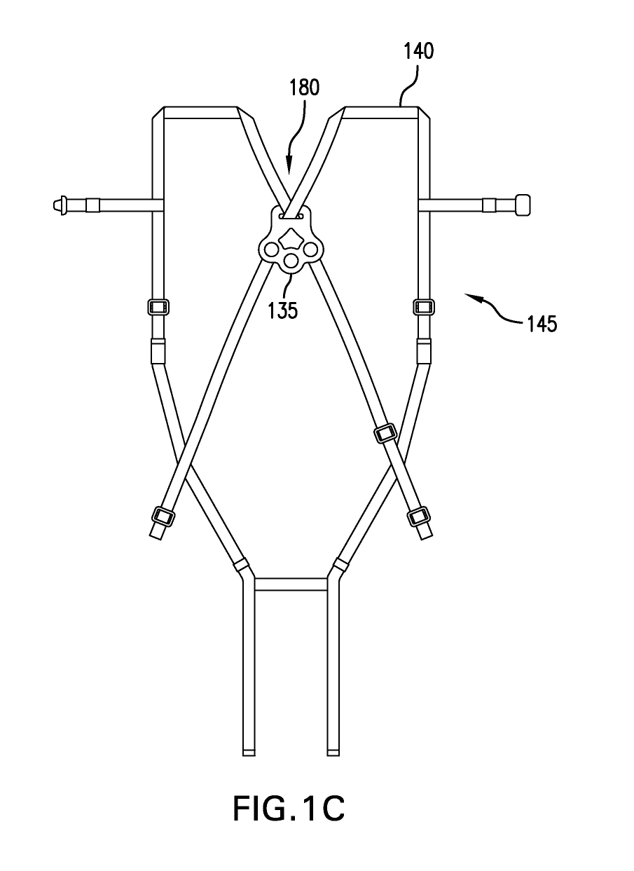

FIGS. 1a-1c depict a sketch of a field implementation of an exemplary Multi-Connector D-Ring (MCDR) used for fall protection. In FIG. 1a, a construction site 100 shows two workers, a fallen worker 105 and an assisting worker 110. The fallen worker 105 is connected to a steel girder 115 via a fall-protection system 120. The fall-protection system 120 has arrested the fall of the fallen worker 105 by connecting the fallen worker 105 to the steel girder 115. The fall-protection system 120 attaches to the steel girder 115 at two points of attachment 125a-b. The assisting worker 110 is using a rescue hook 130 to assist the fallen worker 105. The assisting worker 110 is attaching the rescue hook 130 to an exemplary MCDR 135, shown in FIGS. 1b-1c, the MCDR 135 being part of the fall-protection system 120. The MCDR 135 is attached to the webbing 140 of a safety harness 145, as depicted in FIG. 1c, which the fallen worker 105 is wearing. The MCDR 135 provides multiple device apertures 150a-c to provide connection points to multiple fall-protection safety devices, including, in this example, the two lanyards 155a-b and the rescue hook 130.

In FIG. 1a, the two lanyards 155a-b are connected to the MCDR 135 using two carabiners 160a-b. Because the MCDR 135 has multiple independent device apertures 150a-c, the two lanyard carabiners 160a-b and the rescue hook 130 may each be connected simultaneously and independently to different device aperture 150a, 150c and 150b respectively. In various embodiments, the device apertures 150a-c may be non-intersecting. In some implementations, the device apertures may be arranged to substantially prevent or reduce interference among fall-protection safety devices when connected to the MCDR 135 as depicted in detail in FIGS. 1b-1c.

As depicted in the example shown in FIGS. 1a-1c, the webbing 140 is attached to a Multi-Connector D-Ring (MCDR) 135. In the depicted embodiment, the webbing 140 passes through a webbing aperture 165. The webbing aperture 165 is sized to accommodate the webbing 140. For example, the webbing aperture 165 may have dimensions that are commensurate with those of the webbing 140. In this exemplary figure, the webbing 140 has a cross-sectional geometry of a flat belt, having both a major cross-sectional dimension (e.g., web width) and a minor cross-sectional dimension (e.g., web thickness). The webbing aperture 165 likewise has a major cross-sectional dimension 175a and a minor cross-sectional dimension 175b, both of which being slightly larger than the webbing's respective major cross-sectional dimension and minor cross-sectional dimension. These webbing aperture dimensions 175a-b allow the MCDR 135 to slide along a length of the webbing 140. In this example however, the webbing 140 is arranged in a cross-wise fashion so as to form cross-point 180. In this exemplary figure, the webbing cross-point 180 is located where the webbing 140 passes through the webbing aperture 165. The webbing cross-point 180, being part of the webbing 140, which in turn is part of the safety harness 145, firmly attaches to the webbing aperture 165. In this example, the length of webbing that is slidable through the webbing aperture 165 will be minimal, as the effective major cross-sectional dimension of the webbing increases in both directions away from the webbing cross-point 180.

In this exemplary figure, the MCDR 135 is not only attached to the safety harness 145 via the webbing 140, but the MCDR 135 also is attached to other devices, namely, in this figure, the two carabiners 160a-b and the rescue hook 130. The carabiners 160a-b are attached to the two lanyards 155a-b which in turn are secured to the steel beam 115. The first carabiners 160a are attached to the MCDR 135 using a first device aperture 150a which is sized to properly accommodate the carabiner 160a. The rescue hook 130 is attached to the MCDR 135 through a second device aperture 150b, which is sized to properly accommodate the rescue hook 130. The first and second device apertures 150a and 150b are separated one from another as they are distinct apertures separated by the material of the unitary solid body of the MCDR 135. Being separated, the carabiner 160a and the rescue hook 130 may advantageously avoid entanglement one to another. The first and second device apertures 150a and 150b, being sized to properly accommodate the carabiner 160a and the rescue hook 130 respectively, may advantageously allow the two devices to be better secured to the MCDR 135. For example, each of the apertures 150a-c may be sized to accommodate their intended respective connectors (e.g., carabiners, lanyards, rescue hook, etc.).

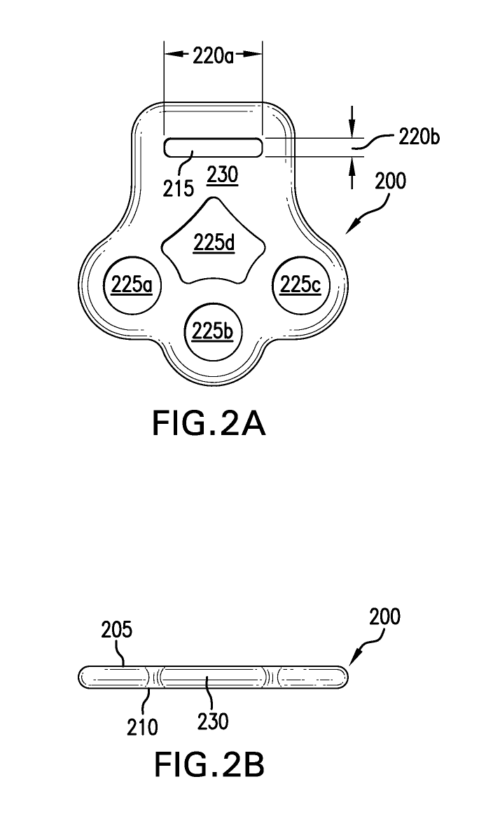

FIGS. 2a-2b show top and side views of an exemplary MCDR. As depicted, an MCDR 200 includes a top surface 205 and a bottom surface 210 that is dimensionally congruent to the top surface 205. The surfaces 205, 210 lie in parallel planes. The MCDR 200 includes a webbing aperture 215 that has dissimilar major and minor dimensions 220a and 220b respectively. Here, the major webbing aperture 220a is much greater than the minor webbing aperture 220b. This example's webbing aperture 215 would appropriately accommodate a webbing that is manufactured of safety-belt material having similarly related major and minor dimensions. If the webbing aperture's minor dimension 220b is sized to be only modestly oversized that of the webbing's minor dimension, the MCDR 200 would thus prevent the webbing from becoming twisted within the webbing aperture 215. Four additional apertures are depicted in this exemplary figure, 225a-d. The large central aperture 225d may be sized simply to reduce material and thus reduce the weight of the MCDR 200, or simply to allow a large general purpose aperture for connection to a fall-protection safety devices. Device apertures 225a-c in this example are all equally sized and shaped to accommodate circular device attachment. The webbing aperture 215 and the apertures 225a-d are formed in a unitary body 230.

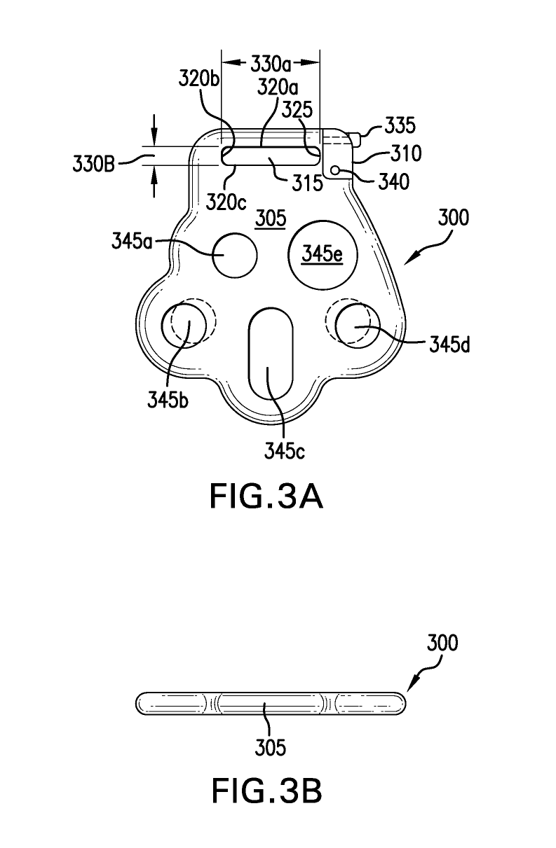

FIGS. 3a-3b show top and side views of an exemplary MCDR. This figure depicts a retrofittable MCDR 300. This exemplary MCDR 300 includes a block 305 and a gate 310. The webbing aperture 315 is circumscribed on three sides by the block's webbing aperture interior sides 320a-c, and on the fourth side by the gate's webbing aperture interior side 325. The resulting webbing aperture has a major dimension 330a and a minor dimension 330b. The gate may be secured to the aperture block, for example, by a fastener or screw 335. In this example the gate is opened by first disconnecting the fastener 335 and then pivoting the gate upon the hinge 340. Many functional gate technologies may well be utilized, so long as the gate may be securely closed and may be opened to accommodate a webbing. Two-action mechanisms may be used to provide the gating function, for example. Furthermore, the gate may be spring loaded and latched so as to automatically and securely close after a webbing is attached. This exemplary figure not only depicts a retrofittable MCDR 300, but it also depicts some device-aperture examples. Five device-apertures 345a-e are shown. Device-aperture 345a is a round aperture sized to accommodate a round device such as a carabiner. Device apertures 345b and 345d are also round, but in this case, the aperture is machined in a direction that is non-perpendicular to both top and bottom surfaces. This may be used to accommodate a lanyard or a cable to be used at an oblique angle, for example. Perhaps the lanyard may be used as a linear guide allowing the lanyard to freely slide through the MCDR. The device aperture 345c is oval. Such an oblong aperture may perhaps accommodate a device with an oval cross-section. It may also be used to allow the device some measure of play along the apertures major dimensional direction. The last device aperture 345e is again round but having a larger aperture area than the other device apertures 345a-d. In this way, dissimilar devices may be simultaneously attached to the MCDR.

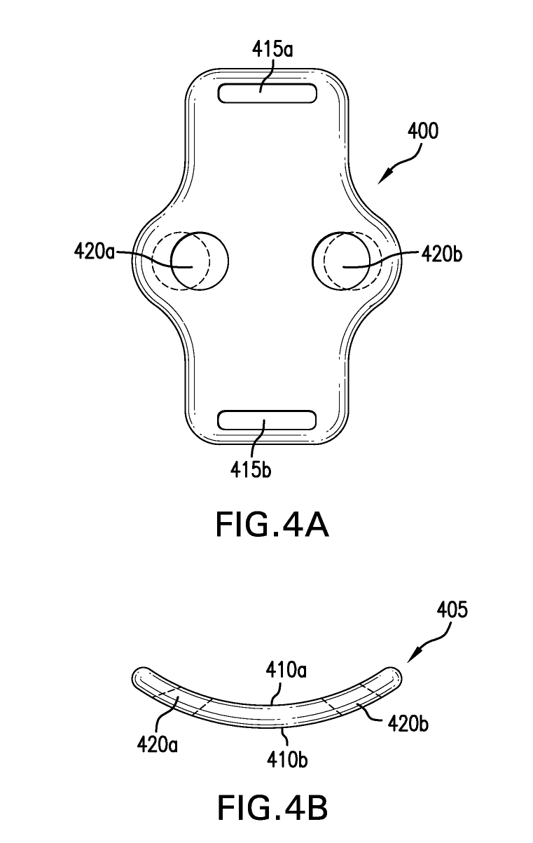

FIGS. 4a-4b show top and side views of an exemplary MCDR. The top-view of the MDCR shows the top surface 400 of the device. The side-view 405 of the MCDR shows the curvature of this example. A top surface 410a and a bottom surface 410b are shown. The MCDR may be dished to form to a body. It may also be dished so as to provide better aperture orientations relative to connecting devices. This exemplary figure depicts two webbing apertures 415a-b arranged in a vertical orientation. These two webbing apertures 415a-b combined with the curvature of the MCDR could allow for a webbing section composed of a single belt to be used in a slidable fashion. Two device-apertures 420a-b are shown here to be machined in a non-perpendicular orientation relative to the top and bottom surfaces 410a-b. This could be used to allow a lanyard or a cable to be slidable in a horizontal fashion as a guide rope, for example. In this example, the curvature may be used for the purpose to conform to a body or to provide such a slidable device attachment. The side-view 405 shows these horizontally arranged device apertures 420a-b as well.

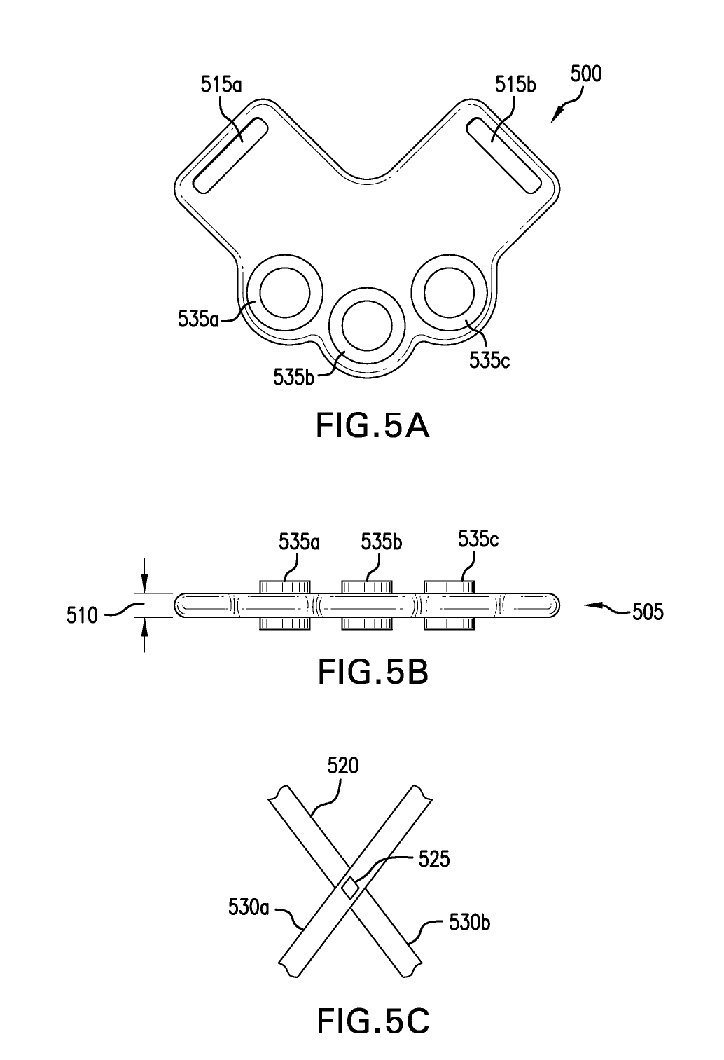

FIGS. 5a-5b show top and side views of an exemplary MCDR. This figure depicts the top-surface 500 of a planar device. The side-view 505 shows the thickness dimension 510. This example shows two diagonal webbing apertures 515a-b. These two apertures could allow for the insertion of a webbing 520 having a cross-point 525. The webbing 520 may be inserted into the MCDR just above the webbing's cross-point 525 so that both webbing belts 530a-b are diagonally attached through their respective webbing apertures 515a-b. This figure also depicts grommets 535a-c, which are located in the device-aperture holes. These grommets 535a-c could be made of plastic, rubber, Teflon, or another material, for example. These grommets 535a-c may provide more or less friction for the attached devices so that device movement may be either facilitated or inhibited. The grommets 535a-c could also provide for a gentler connection so that wear and tear of the device connectors is minimized Another similar implementation could encase the entire MCDR in rubber or other material.

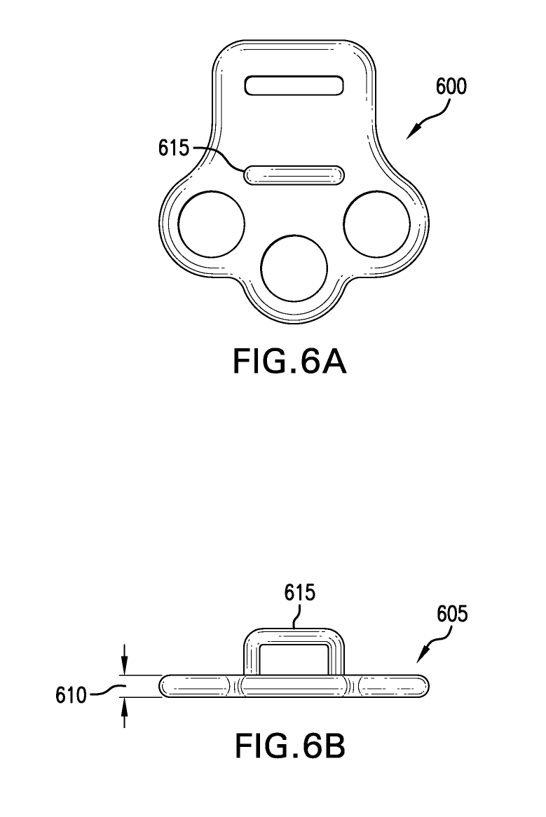

FIGS. 6a-6b show top and side views of an exemplary MCDR. This figure shows the top-view 600 of an MCDR with a planar body. The side-view 605 shows the cross-sectional dimension 610 as well as a projecting fixture 615. In this example, the projecting fixture 615 is in the form of a loop. Such a loop could facilitate the rescue of a fallen man by providing for a convenient loop for a rescue hook. The top-view 600 shows the projecting fixture 615 aligned so that the resulting loop is oriented to the top and bottom of the MCDR 600. Such a fixture perhaps allows the wearer of the MCDR protection from the rescue hook, as the body of the MCDR is interposed between the wearer and the hook.

Although various embodiments have been described with reference to the Figures, other embodiments are possible. Some embodiments, for example, may increase the separation distance between the plurality of device apertures. This may reduce the interaction of multiple carabiners with one another, for example. Carabiners typically have a mechanism that requires two actions to open. The two-action mechanism helps prevent an inadvertent and accidental opening of the carabiner. Accidental openings of fall-protection safety devices may be catastrophic. Such an event may result in the death of a construction worker or rock climber. As the wearer of a safety harness moves, the carabiners may bang each other or otherwise rattle around, if the carabiners are all secured to the same aperture. There are two hazards that arise because of this interaction. One, the fall-protection devices, which are connected to the D-ring, may become tangled up with one another. Two, the likelihood increases that one or more of the two-action mechanisms will be activated and the connector or connectors will then accidentally open. Thus, widely separated apertures will minimize the possibility of carabiner interaction.

In another embodiment, for example, the curvature of the MCDR need not simply conform to a portion of a human body, but may be used to provide better access to the apertures by providing some distance between the human body and the apertures. For example, raised portions of the MCDR may in this way provide apertures to which devices may be connected more easily and without risk of injuring the person wearing the safety harness which provides the MCDR.

In various embodiments, the apparatus and methods may involve slotted or elongated apertures, for example, to allow for linear movement of the attached device. In some embodiments, the MCDR may include two small device apertures and one large device aperture. The large device aperture may accommodate a larger attachment element, for example.

In an exemplary embodiment, the MCDR may be rubberized. This rubberized MCDR may be performed for many reasons, including wear protection, noise reduction, and comfort. The rubberized MCDR also provides the connectors with more friction so that the connector movement will be suppressed.

In accordance with another embodiment, rubberization may be performed locally in the device or webbing aperture regions of the MCDR. Rubber grommets may be used to provide such a solution. In accordance with another embodiment, Teflon may be used as grommet material to provide for a device connection with a lubricating effect. In accordance with another embodiment, plastic may be used as grommet material.

In accordance with an exemplary embodiment, titanium may be used as a material for the MCDR. In this way the MCDR may be made light without compromising the strength of the apparatus. In another exemplary embodiment, steel is used as the MCDR material.

In some embodiments that include a first and a second webbing aperture, the first webbing aperture may have a first major dimension that is different than a first major dimension of the second webbing aperture. For example, some embodiments may insert a first webbing through the first webbing aperture that has a different width than a second webbing that is inserted through the second webbing aperture.

In accordance with another embodiment, the device holes may be chamfered so as to allow the connecting device the ability to rotate in the MCDR device hole. In a similar manner, another exemplary embodiment may have chamfered webbing apertures to prevent chafing to the webbing or to allow the webbing to be slidable in the aperture. And in another exemplary embodiment, fixtures are attached to solid body portion of the MCDR. Various devices could be firmly attached to provide a variety of functions. One such example of such a device may be a shock switched lamp. Such a lamp would light up in the event of a fall.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A fall-protection safety apparatus for connecting a webbed safety harness to other devices, the apparatus comprising:
a unitary solid body with a top and a bottom surface, the unitary solid body comprising:
a webbing aperture extending through the body between the top surface and the bottom surface, the webbing aperture having a major dimension sized to receive a webbing having up to a predetermined width and having a minor dimension sized to receive the webbing's thickness such that the unitary solid body is slidable along a length of the webbing; and
a plurality of non-intersecting device apertures extending through the body between the top surface and the bottom surface, wherein each of the plurality of device apertures is adapted to receive a respective connector of a fall-protection safety device.

2. The fall-protection safety apparatus of claim 1, wherein the webbing aperture has an opening mechanism and a latching mechanism.

3. The fall-protection safety apparatus of claim 1, further comprising an additional webbing aperture extending through the body between the top surface and the bottom surface, the webbing aperture having a major dimension sized to receive a webbing having up to a predetermined width and having a minor dimension sized to receive the webbing's thickness such that the unitary solid body is slidable along a length of the webbing.

4. The fall-protection safety apparatus of claim 1, wherein the plurality of device apertures comprises two non-intersecting apertures.

5. The fall-protection safety apparatus of claim 1, wherein the plurality of device apertures comprises at least three non-intersecting apertures.

6. The fall-protection safety apparatus of claim 1, wherein the unitary solid body is curved to form to a portion of a human body.

7. The fall-protection safety apparatus of claim 1, further comprising a webbing, the webbing connected to the unitary solid body by passing through the webbing aperture, the webbing capable of being secured to another object.

8. The fall-protection safety apparatus of claim 7, further comprising a safety harness that includes the webbing.

9. A method of constructing a fall protection safety harness, the method comprising:
providing a wearable safety harness that comprises a length of webbing;
providing a unitary solid body with a top and a bottom surface, the unitary solid body comprising:
a webbing aperture extending through the body between the top surface and the bottom surface, the webbing aperture having a major dimension sized to receive a webbing having up to a predetermined width and having a minor dimension sized to receive the webbing's thickness such that the unitary solid body is slidable along the length of the webbing; and
a plurality of non-intersecting device apertures extending through the body between the top surface and the bottom surface, wherein each of the plurality of device apertures is adapted to receive a respective connector of a fall-protection safety device; and,
inserting at least a portion of the length of the webbing through the webbing aperture to securely couple the unitary solid body to the safety harness.

10. The method of claim 9, further comprising inserting a connecting device through one device aperture of the plurality of device apertures.

11. The method of claim 9, further comprising inserting a second connecting device through a second device aperture of the plurality of device apertures.

12. The method of claim 9, wherein the step of inserting the webbing through the webbing aperture comprises:
opening an opening mechanism;
inserting the webbing through the opening mechanism;
closing the opening mechanism; and
securing the opening mechanism.

13. The method of claim 9, further comprising connecting a safety harness to the webbing, wherein the webbing is an integral portion of the safety harness.

14. The method of claim 9, wherein the plurality of non-intersecting device apertures includes at least two device apertures.

15. The method of claim 9, wherein the plurality of non-intersecting device apertures includes at least three device apertures.

16. The method of claim 9, further providing the wearable safety harness comprises a second length of webbing, and further comprising inserting at least a portion of the second length of webbing through a second webbing aperture extending through the body between the top surface and the bottom surface, the second webbing aperture having a major dimension sized to slidably receive the second length of webbing having up to a second predetermined width and having a second minor dimension sized to slidably receive the second length of webbing's thickness.

17. The method of claim 16, wherein the first major dimension and the second major dimension are substantially equal.

18. A fall-protection safety apparatus for connecting a webbed safety harness to other devices, the apparatus comprising:
a unitary solid body with top and bottom surfaces;
means for coupling the unitary solid body to a webbing; and
means for coupling the unitary solid body to a plurality of fall-protection safety devices.

19. The device of claim 18, further comprising means for retrofitting the apparatus to a closed webbing.

20. The device of claim 18, wherein the unitary solid body is curved to form to a portion of a human body.
